(19) United States
(12) Patent Application Publication
(10) Pub. No.: US 2013/0301839 A1
(43) Pub. Date: Nov. 14, 2013

(54) SOUND SYNTHESISER

(71) Applicant: PETER VOGEL INSTRUMENTS PTY LTD, (US)

(72) Inventor: PETER SAMUEL VOGEL, FAULCONBRIDGE (AU)

(21) Appl. No.: 13/865,204

(22) Filed: Apr. 18, 2013

(30) Foreign Application Priority Data
Apr. 19, 2012 (AU) 2012901539

(51) Int. Cl. G10H 5/00

(52) U.S. Cl. CPC G10H 5/005
USPC 381/61

(57) ABSTRACT

A system for synthesising sounds which allows the user to specify time varying functions for multiple partials. The partials can be cyclical waveforms, for example sine waves, or sampled sounds, or a mixture of each. Partials can be included in the resulting sound by summing, convolution or otherwise. Time varying functions can be specified for the amplitude, frequency or other characteristic of each partial. In some embodiments the resulting waveform can be displayed in various formats to assist with visualising the result of the synthesis.

### FIELD OF THE INVENTION

The present invention relates to systems for electronically creating and manipulating sounds, particularly for musical or sound design purposes.

### BACKGROUND OF THE INVENTION

Systems for synthesising sounds electronically were made popular with the development of analogue music synthesizers in the 1960s. Such synthesizers typically utilised oscillators which generate a cyclical waveform as the basic sound source. The output of the oscillators were further modified by circuits which performed filtering or other processing to change the character of the sound. Multiple oscillators producing different waveforms or frequencies were sometimes synchronised to produce more complex sounds when added together.

During the 1980s it became common for digital systems to be used for sound synthesis, some of which included the ability to sample sounds from the real world into memory and use these as the basis for music production by changing their pitch. One of the first commercially successful sampling instruments was the Computer Musical Instrument developed by the Australian company Fairlight Instruments Pty Ltd. In addition to the ability to play sampled sounds, the CMI also provided means for synthesising sounds by adding sine waves of harmonically related partials. The user could draw a time-vs-amplitude function for each of the desired partials. While it is possible to synthesise interesting and useful sounds using such harmonic synthesis, the results often lack the complexity and richness of naturally occurring sampled sounds.

There is a need for an easy-to-use system for effectively combining harmonic synthesis with sampled sounds in musically pleasing ways.

### SUMMARY OF THE INVENTION

It is an object of this invention to provide a system for synthesising sounds using partials which can be cyclical waveforms or arbitrary sampled waveforms or a mix of cyclical and sampled partials.

It is a further object of the invention to provide a system for synthesising sounds using partials which can be combined in a variety of ways, such as summation (mixing) and convolution.

It is a further objective of the invention to provide a system for synthesising sounds using partials including interactive display of the defining parameters and resulting waveform.

In one aspect the present invention provides a sound synthesiser comprising means for receiving input from an operator selecting a set of audio waveforms, means for receiving input from an operator defining a plurality of time-varying functions, and means for algorithmically combining at least two of said audio waveforms according to said time-varying functions.

In an extension of the inventive concept, means are also provided for displaying a graphic representation of the resulting combined waveform.

In some embodiments, the combining algorithm includes a mixing step. In other embodiments, the combining algorithm includes a convolving step.

### DESCRIPTION OF PREFERRED EMBODIMENT

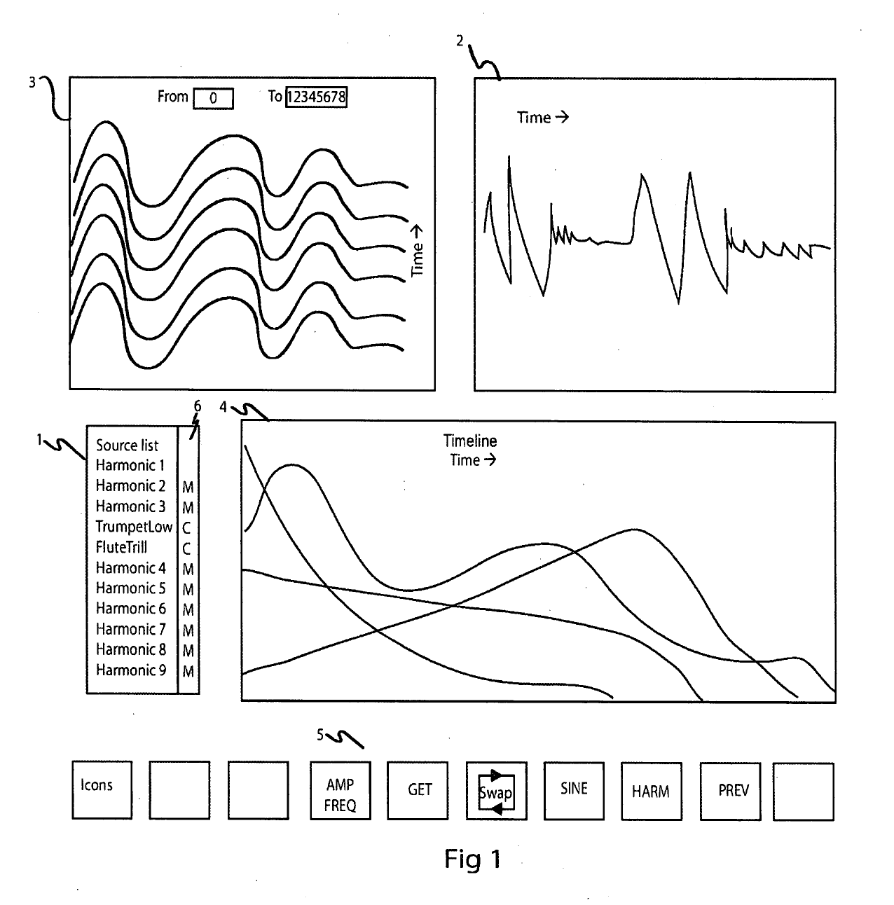

An embodiment of the invention will now be described with reference to the drawings in which FIG. 1 is a representation of the user interface of an embodiment of the present invention.

In this embodiment, the invention is practised using a general purpose computer equipped with a graphical user interface and a digital to analogue converter (DAC). The DAC is used as the audio output device.

Referring now to FIG. 1, an exemplary user interface display of the invention is seen. The partials to be used to synthesise a sound can be either cyclical waveforms or sampled sounds. Sampled sounds are stored in the memory of the invention (typically RAM, flash or disk storage). Cyclical waveforms can be similarly stored, or they could be synthesised algorithmically by the computer, in which case the source waveform need not be stored at all. Cyclical waveform partials are usually sine waves although they can be other waveforms such as square, triangular, sawtooth or other repeating waveform.

The user specifies a number of partials to be used for the synthesis and these are identified in the source list (1). In this example, nine sine waves “harmonic 1” to “harmonic 9” are used, harmonic 1 being the fundamental frequency and each harmonic being the appropriate integer multiple of the fundamental frequency. In this example, sampled sounds called “trumpetlow” and “flutetrill” have also been selected as partials to be used in the synthesis.

Timeline (4) is an area where the user can draw curves which represent the time-varying amplitude or frequency function for each partial. The left side of the timeline corresponds to time zero, that is the start of the synthesised sound.

Algorithm selector (6) is a column in which the user places a letter to designate which of a range of algorithms will be applied to the corresponding partial when synthesising, In this example, there are two algorithms to choose from, mixing (M) and convolving (C).

When the user issues a synthesise command, the computer of the invention executes computational steps which result in the partials being synthesised as follows. The first partial (at the top of the list) is scaled over time according to the amplitude curve defined for that partial and its frequency is shifted according to the frequency curve defined for that partial. The scale for amplitude is maximum when the curve is at the top of the timeline drawing area (4) and minimum when at the bottom. Frequency shift is zero when the curve is mid-way on the vertical axis of the drawing area and varies plus one semitone for maximum upwards excursion of the curve and minus one semitone for maximum downwards excursion.

The next partial in the list is then processed and combined with the previous result according to the algorithm specified for that partial. In this example, the second partial is mixed with the first (after frequency and amplitude modulation).

This process is repeated for the third partial (also mixed).

The fourth partial, a sampled sound in this example, is frequency and amplitude modulated according to the user-drawn curves, and the result is then convolved with the waveform accumulated from partials 1 to 3.

Convolution of a signal with another signal means that a copy of the second signal is placed into the output for every sample in the first signal. The copy is scaled by each value in the first signal. Convolution is widely used in the audio processing art, particularly for reverberation effects in which case one of the signals is an impulse. In the present invention one of the partials may optionally be an impulse, but interesting and useful sounds can be synthesised using sounds other than impulses as the sources. In this example some sort of trumpet and flute sounds are convolved with mixed harmonically-related sine waves, resulting in a novel sound which is somewhat electronic sounding but with a flute-ish and trumpet-ish character imposed.

In this exemplary embodiment, on-screen buttons (5) are provided for commonly-used operations and displays (2) and (3) are used to give the user visibility of the resulting synthesised sound. Display (2) is a conventional oscilloscope-like display of the waveform, and display (3) is a “waterfall” display which stacks cycles of the sound in three dimensions so that the progressive change in waveform over time is more easily seen. These displays are updated immediately a change is made to the timeline functions, and tools are also provided to enable further editing or modification of the synthesised sound, for example by editing the waveform, applying filters, or setting loop points.

Furthermore, it will be obvious to those skilled in the art that the embodiment described herein is exemplary only and many variations can be made without departing from the scope of the invention.

For example, whereas the time varying functions to be applied to each partial are described herein as amplitude and frequency variations, the invention is not so limited, and other time-varying modifiers can be used with good result, for example filters with time-varying frequency or resonance could be applied.

Although the invention as herein described uses digital waveforms as the source partials, this is exemplary only and it will be understood that the invention can also be practised using analogue sources such as oscillators.

Although the preferred embodiment is described as using both cyclical and sampled waveforms to synthesise a sound, the invention can be beneficially implemented using only sampled sounds or only cyclical sounds.

1. A sound synthesiser comprising means for receiving input from an operator selecting a set of audio waveforms, means for receiving input from an operator defining a plurality of time-varying functions, and means for algorithmically combining at least two of said audio waveforms according to said time-varying functions.

2. A sound synthesiser according to claim 1 wherein at least one of said audio waveforms is a cyclical waveform and at least one of said audio waveforms is an arbitrary sampled sound waveform.

3. A sound synthesiser according to claim 1 wherein said algorithmic combining means is adapted to perform a convolution of two sound waveforms.
